(19) United States
(12) Patent Application Publication
(10) Pub. No.: US 2008/0152131 A1
(43) Pub. Date: Jun. 26, 2008

(54) Data transfer device

(76) Inventor: Daigo SENOO, Osaka (JP)

Correspondence Address: MCDERMOTT WILL & EMERY LLP, 600 13TH STREET, NW, WASHINGTON, DC, 20005-3096, US

(21) Appl. No.: 11/905,531

(22) Filed: Oct. 2, 2007

(30) Foreign Application Priority Data
Dec. 21, 2006 (JP) 2006-344443

(51) Int. Cl. H04L 9/18

(52) U.S. Cl. 380/42

(57) ABSTRACT

A data transfer device is provided for descrambling and deinterleaving scrambled interleaved data and transferring the resultant data. An interleave memory stores interleaved data in descrambling units. A DMA device outputs data position information indicating a storage position of each byte of the interleaved data stored in the interleave memory. A descrambling device receives data read out from each column of the interleave memory 13 in units of n bytes (n is a positive integer), and descrambles the data based on the data position information output from the DMA device.

### CROSS REFERENCE TO RELATED APPLICATIONS

This Non-provisional application claims priority under 35 U.S.C. §119(a) on Patent Application No. 2006-344443 filed in Japan on Dec. 21, 2006, the entire contents of which are hereby incorporated by reference.

### BACKGROUND OF THE INVENTION

1. Field of the Invention

The present invention relates to a data transfer device which performs descrambling and deinterleaving with respect to interleaved data which is scrambled and obtained from an optical disc, such as representatively a Blu-ray disc, and transfers the resultant data.

2. Description of the Related Art

According to the Blu-ray standards, raw data, such as video data or the like, is recorded onto a disc after a scrambling process and an interleaving process in which data is rearranged are performed. Therefore, Blu-ray discs are conventionally processed by the following procedure using a configuration as shown in FIG. 24.

Initially, data stored on a disc 1 is subjected to demodulation and synchronization detection by a data synchronization detecting circuit 2. Thereafter, a deinterleaving device 3 performs deinterleaving (i.e., cancellation of interleave) before loading data into a memory device 4. In this case, initially, first interleave may be canceled in an intermediate buffer, such as an SRAM or the like, and second interleave may be then canceled in a main memory device (see, for example, International Publication WO2006/035572).

Thereafter, an error correction device (ECC) 5 performs error correction for interleave (see, for example, International Publication WO2004/109694). Thereafter, a descrambling device 6 is used to descramble scrambled data, and an EDC operation device 7 is used to perform an EDC operation to perform final error detection. If no error is found, a host transfer device 8 is used to transfer data to a host.

In the case of DVDs, a process can be performed using, for example, a configuration as shown in FIG. 25. Specifically, data stored on a disc 51 is subjected to demodulation and synchronization detection by a data synchronization detecting circuit 52, and is also subjected to descrambling by a descrambling device 53. The resultant data is loaded into a main memory device 54. Thereafter, ECC and rescrambling are performed by an error correction device 55, while an EDC operation is performed by an EDC operation device 56. In some cases, correction calculation is performed to detect an error. Thereafter, a host transfer device 57 is used to transfer data.

In the configuration of FIG. 24, scrambled data is loaded into the main memory device 4, and four masters access the main memory device 4. In contrast to this, in the configuration of the FIG. 25, descrambled data (raw data) is loaded into the main memory device 54, and only three masters access the main memory device 54. Therefore, the configuration of the FIG. 25 has the following advantages:

1. descrambled data is loaded which has the same data format which is actually accessed by a PC or the like, thereby facilitating data processing or debugging;

2. the number of masters is reduced to three, thereby increasing a rate at which data is transferred to a main memory device per master; and

3. a descrambling operation during demodulation has a filter structure, so that a data processing time does not increase as compared to typical demodulation, and therefore, an original transfer rate is not reduced.

When the configuration of FIG. 24 is modified into the configuration of FIG. 25, the following problem arises. Specifically, in the case of DVDs, since an interleaving process is not performed, the order of data from a disc in which the data is demodulated is the same as the order of data from a disc in which the data is descrambled. Therefore, demodulation and descrambling are relatively easily simultaneously performed. However, in the case of Blu-ray discs, due to the existence of interleave, the order of data from a disc which the data is demodulated is different from the order of data from a disc in which the data makes sense. Therefore, demodulated data cannot be simply descrambled, and a descrambling process needs to be performed, taking interleave into consideration.

### SUMMARY OF THE INVENTION

An object of the present invention is to provide a data transfer device which performs descrambling and deinterleaving with respect to scrambled interleaved data, and transfers the resultant data.

The present invention provides a data transfer device for descrambling and deinterleaving scrambled interleaved data and transferring the resultant data to a main memory device. The interleaved data has an interleave unit including B sectors of scrambled original data (A bytes/sector) arranged in C rows×D columns (A, B, C, and D are positive integers, A×B=C×D). The device comprises an interleave memory for storing the interleaved data in descrambling units, the describing unit being a group of data to be descrambled, a DMA device for outputting data position information indicating a storage position of each byte of the interleaved data stored in the interleave memory, and address information for deinterleaving, and a descrambling device for receiving data read out from each column of the interleave memory in units of n bytes (n is a positive integer), and descrambling the data based on the data position information output from the DMA device. The address information output from the DMA device is supplied to the main memory device while the output data of the descrambling device is transferred to the main memory device. The descrambling device comprises a filter operation section for obtaining a filter value to be updated by a shift operation on a byte-by-byte basis based on the data position information, and an EXOR operation section for performing an EXOR operation of input data and the filter value obtained by the filter operation section.

According to the present invention, interleaved data which has an interleave unit including B sectors of scrambled original data (A bytes/sector) arranged in C rows×D columns (A, B, C, and D are positive integers, A×B=C×D), is stored in descrambling units, the describing unit being a group of data to be descrambled. In the descrambling device, for input data read out from each column of the interleave memory in units of n bytes, a filter value is obtained based on the data position information output from the DMA device. The input data and the filter value are subjected to an EXOR operation. The output data of the descrambling device is transferred to the main memory device, and the address information for deinterleaving output from the DMA device is supplied to the main memory device. Thereby, descrambling as well as deinterleaving are executed.

According to the present invention, scrambled interleaved data can be deinterleaved and descrambled, so that descrambled data can be loaded into the main memory device.

### BRIEF DESCRIPTION OF THE DRAWINGS

FIG. 1 is a block diagram showing a configuration of a data transfer device according to a first embodiment of the present invention.

FIG. 2 is a block diagram showing an internal configuration of a descrambling device of FIG. 1.

FIG. 3 is a diagram showing an operation for a scrambling process.

FIG. 4 is a diagram showing scrambled original data.

FIG. 5 is a diagram for describing an interleaving method, showing data obtained from the original data of FIG. 4.

FIG. 6 is a diagram for describing the interleaving method, showing data obtained by adding a parity to the data of FIG. 5.

FIG. 7 is a diagram for describing the interleaving method, showing data obtained from the data of FIG. 6.

FIG. 8 is a diagram for describing the interleaving method, showing data obtained from the data of FIG. 7.

FIG. 9 is a diagram showing a format of a data stream.

FIG. 10 is a diagram showing data of a descrambling unit stored in an interleave memory.

FIG. 11 is a diagram showing data of a descrambling unit stored in an interleave memory.

FIG. 12 is a block diagram showing an internal configuration of a descrambling device according to a second embodiment.

FIG. 13 is a diagram schematically showing a filter updating process according to the second embodiment of the present invention.

FIG. 14 is a diagram schematically showing the filter updating process of the second embodiment of the present invention.

FIG. 15 is a block diagram showing a configuration of a data transfer device according to a third embodiment of the present invention.

FIG. 16 is a block diagram showing a configuration of a data transfer device according to a fourth embodiment of the present invention.

FIG. 17 is a block diagram showing an internal configuration of a descrambling device of FIG. 16.

FIG. 18 is a diagram showing data of one interleave unit.

FIG. 19 is a diagram showing timing of a normal interleaving operation.

FIG. 20 is a diagram showing a relationship between frames of FIG. 18 and the movements of a plane when data jump occurs.

FIG. 21 is a flowchart showing an operation when synchronization abnormality occurs according to a fourth embodiment of the present invention.

FIG. 22 is a diagram showing exemplary operation timing when synchronization abnormality occurs.

FIG. 23 is a diagram showing exemplary operation timing when synchronization abnormality occurs.

FIG. 24 is a diagram showing an exemplary system configuration of conventional Blu-ray discs.

FIG. 25 is a diagram showing an exemplary system configuration of DVDs.

### DETAILED DESCRIPTION OF THE PREFERRED EMBODIMENTS

Hereinafter, embodiments of the present invention will be described with reference to the accompanying drawings.

### First Embodiment

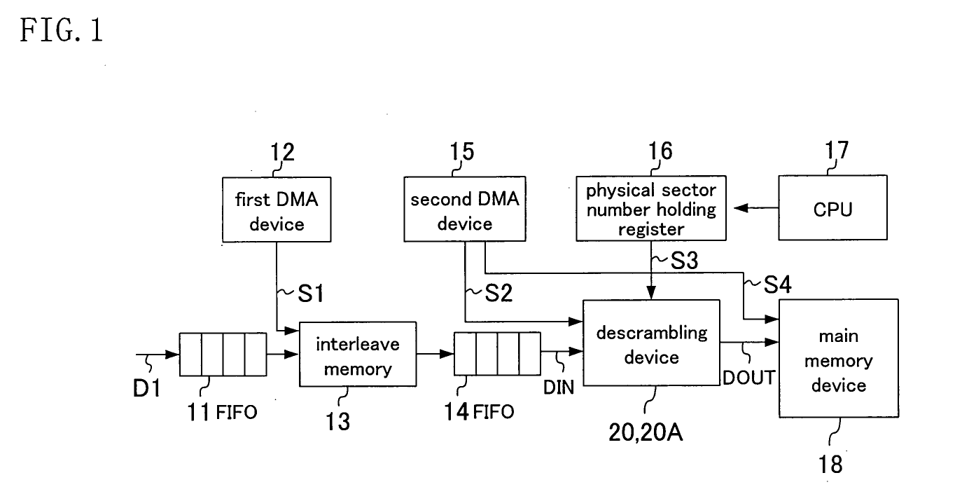

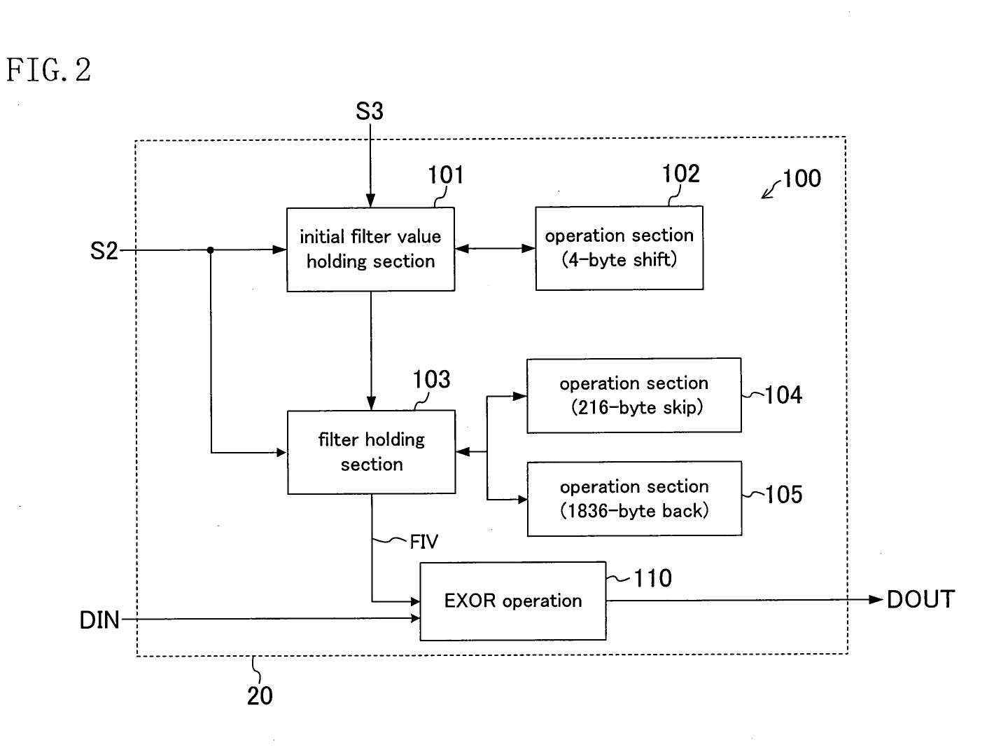

FIG. 1 is a block diagram showing a configuration of a data transfer device according to a first embodiment of the present invention. The data transfer device of FIG. 1 halfway deinterleaves an input data stream D1 and stores the resultant data into an interleave memory 13. Thereafter, a descrambling device 20 descrambles and deinterleaves the interleaved data DIN stored in the interleave memory 13 and stores the resultant descrambled data DOUT into a main memory device 18. FIG. 2 is a block diagram showing an internal configuration of the descrambling device 20 of FIG. 1.

Scrambling and interleaving will be now described in relation to, for example, the Blu-ray standards.

Initially, raw data, such as video before interleaving or the like, is divided into 2048-byte segments in a main memory device, and a 4-byte EDC for error detection is added to each segment. The EDC-added 2052 bytes are subjected to a scrambling process.

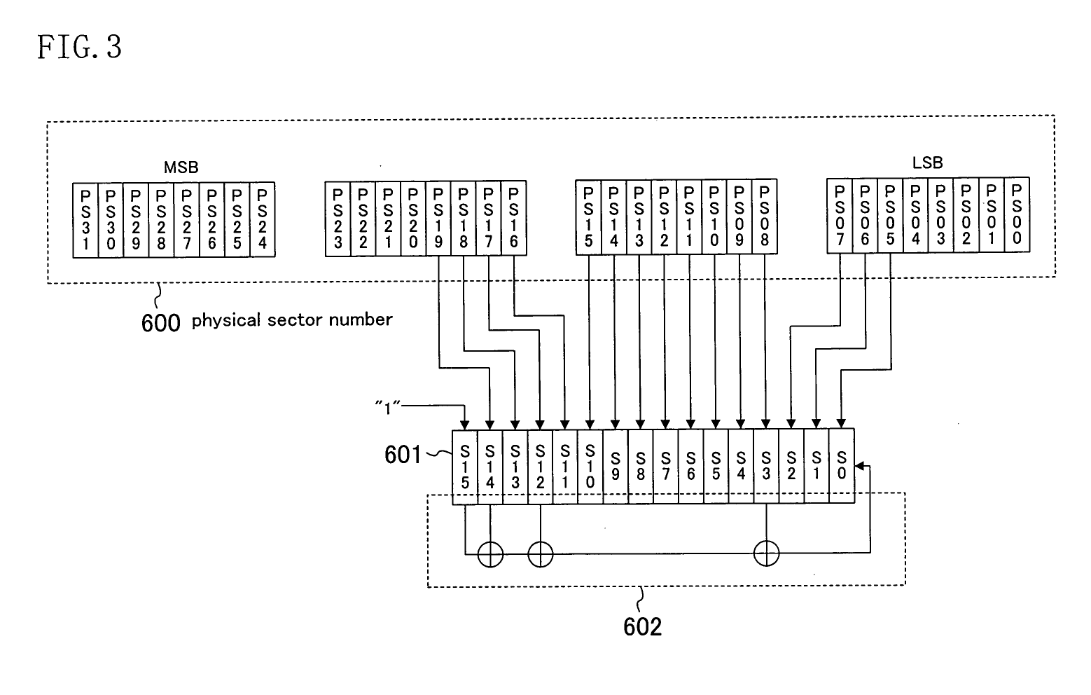

FIG. 3 is a diagram showing an operation for the scrambling process. In FIG. 3, a physical sector number 600 is 4-byte information. Bits 5 to 19 of the physical sector number 600 are input as initial values to bits 0 to 14 of a seed 601. “1” is input as an initial value to bit 15 of the seed 601. The eight lower bits of the seed 601 are used as a filter for scrambling. Specifically, an EXOR operation of one-byte raw data and the eight lower bits of the seed 601 results in scrambled data. When the next one-byte data is scrambled, an operation 602 is used to perform a shift operation eight times, and after this operation, the resultant data and the eight lower bits of the seed 601 are subjected to an EXOR operation. Such a process is repeatedly executed for 2052 bytes.

Such a physical sector number as an initial value is a number which is incremented in units of 2052 bytes. Therefore, the values of bits 5 to 19 used as initial values are not changed in 32 sectors which are a unit for interleaving.

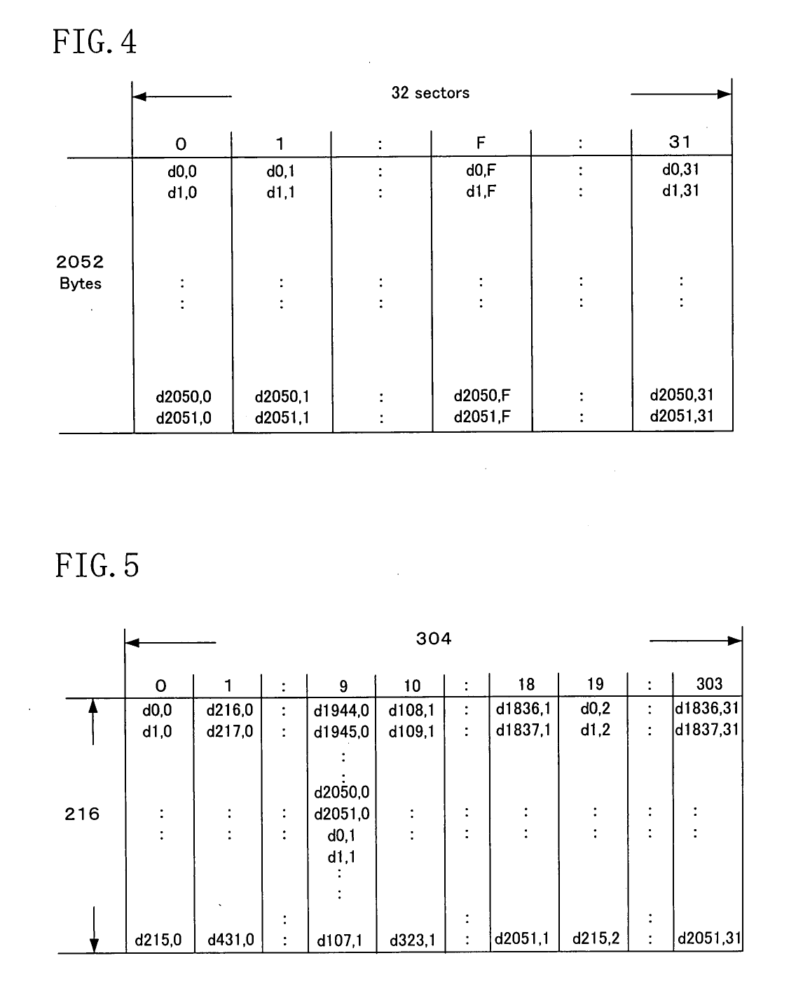

Next, the scrambled data thus obtained is arranged horizontally in 32 sectors and vertically on a byte-by-byte basis in each sector as shown in FIG. 4. This 32-sector data (2052 bytes/sector) is used as original data which has been scrambled.

Next, the data of FIG. 4 is divided into 304 segments each including 216 bytes, i.e., is rearranged in 216 rows×304 columns, as shown in FIG. 5 (2052×32=216×304).

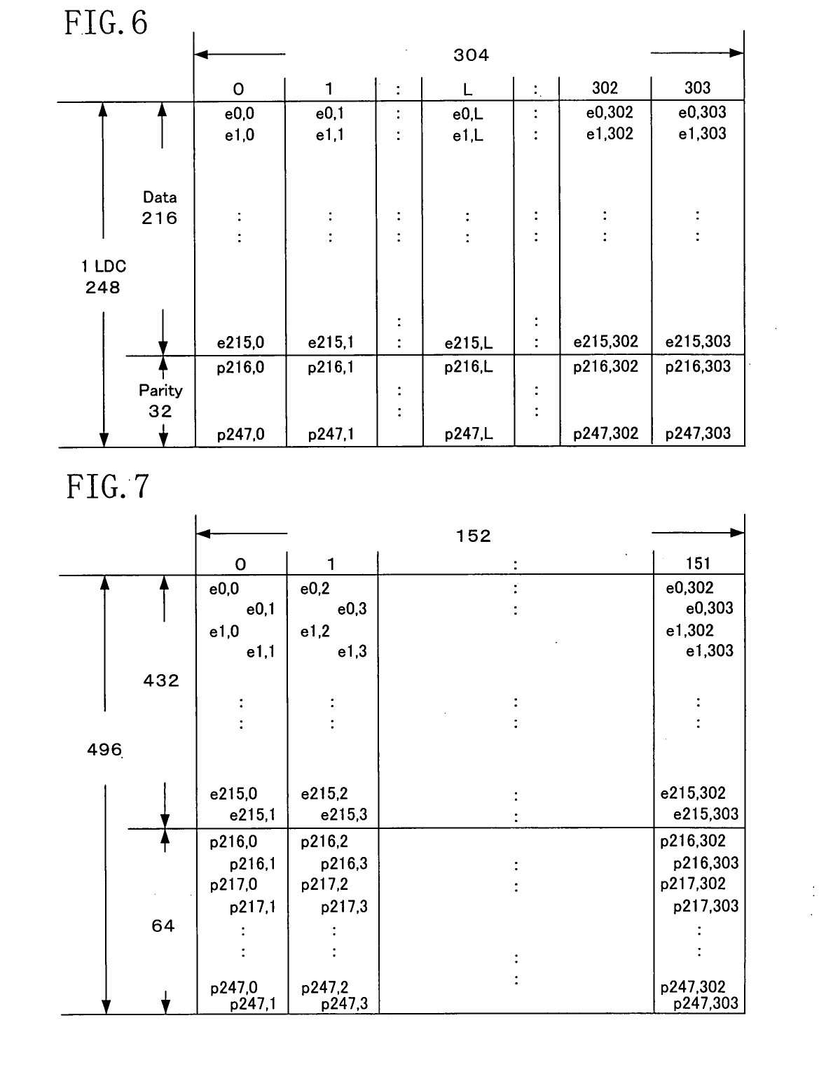

Next, a 32-byte parity is added to each column of the data of FIG. 5, thereby obtaining data as shown in FIG. 6. Note that the nature of the present invention does not depend on a method of adding the parity, which will not be therefore described.

Further, in the data of FIG. 6, an even-numbered column (including a column 0) and an odd-numbered column which are adjacent to each other are grouped into one column. When the columns are grouped into one column, the data of the even-numbered column and the data of the odd-numbered column are alternately arranged. Thereby, data of 496 rows×152 columns is obtained as shown in FIG. 7.

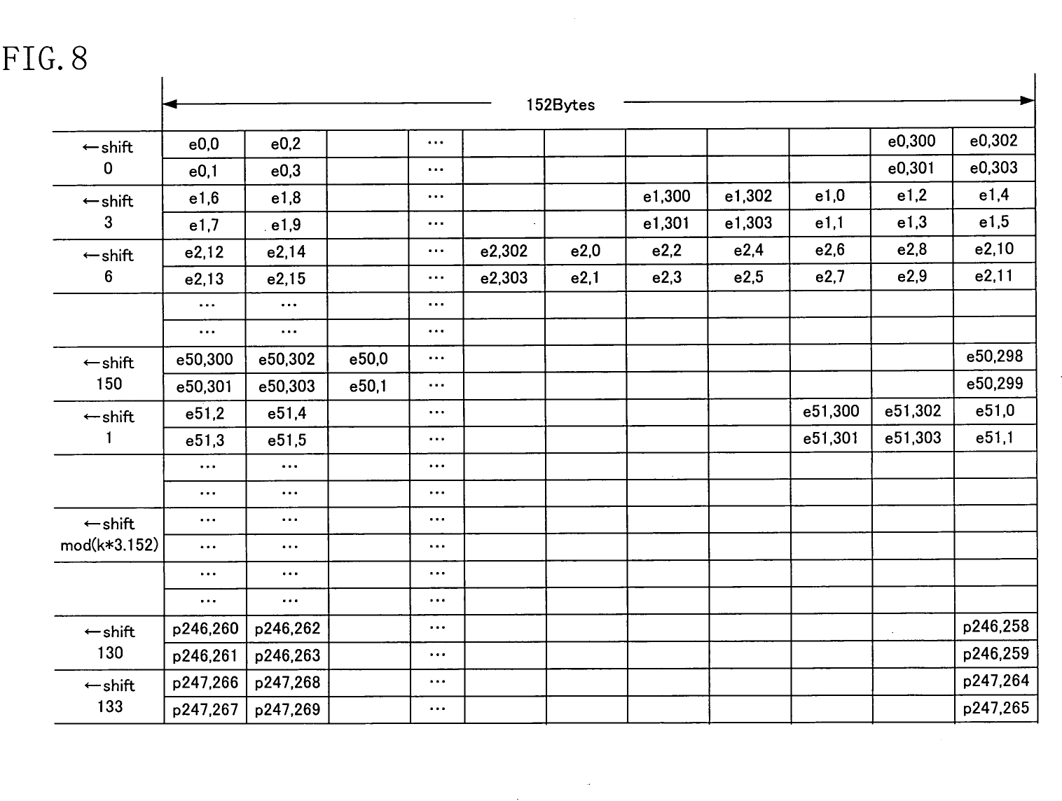

Finally, the data of FIG. 7 is shifted in units of two rows as shown in FIG. 8. The shift amount is increased by three bytes every shift process. Note that, when the shift amount exceeds 152 bytes, a remainder obtained by dividing the shift amount by 152 is an actual shift amount. For example, a shift amount next to 150 bytes is one byte.

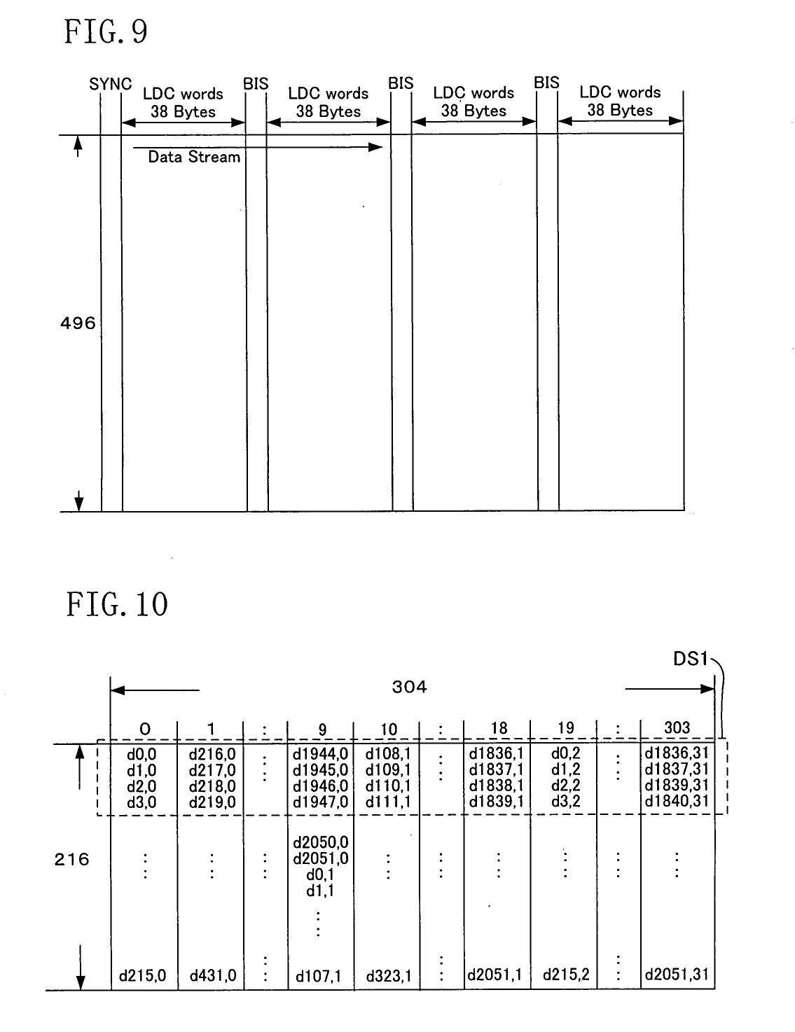

The thus-generated 152-byte data on each row as shown in FIG. 8 is divided into four, thereby obtaining a data stream with a format as shown in FIG. 9.

In this embodiment, the data stream as shown in FIG. 9 is input as the data stream D1. The data stream D1 is, for example, reproduced from an optical disc by a demodulation device.

In FIG. 1, an FIFO memory 11 outputs the input data stream D1 in units of one byte. A first DMA device 12 stores a relationship between the data stream D1 and the format of FIG. 5 and outputs address information S1 for deinterleaving. The address information S1 output from the first DMA device 12 is input to the interleave memory 13, so that the interleaved data stream D1 is halfway deinterleaved, and therefore, the resultant interleaved data as shown in FIG. 5 is stored in the interleave memory 13.

In this embodiment, the interleaved data stream of FIG. 9 is deinterleaved in units of eight rows. Thereby, in the interleave memory 13, data DS1 corresponding to four rows is stored as shown in FIG. 10 (the same as that of FIG. 5). The four-row data is a group of data to be descrambled. This is hereinafter referred to as a descrambling unit.

As can be seen from FIG. 10, in the interleaved data DS1 which is stored in the descrambling units in the interleave memory 13, 4-byte continuous data is provided in each of the 304 columns wherein one 4-byte data is spaced by 216 bytes from the next 4-byte data. In this embodiment, such interleaved data DS1 is subjected to descrambling by the descrambling device 20.

Specifically, an FIFO memory 14 successively outputs the interleaved data which is read out from each column of the interleave memory 13 in units of four bytes, as the input data DIN, to the descrambling device 20. A second DMA device 15 outputs data position information S2 which indicates a position of each byte in the interleaved data stored in the interleave memory 13. A physical sector number holding register 16 outputs a physical sector number S3 set by a CPU 17. The descrambling device 20 uses the data position information S2 and the physical sector number S3 to obtain a filter value for descrambling. Thereafter, the filter value and the input data DIN are subjected to an EXOR operation to obtain the descrambled output data DOUT. The second DMA device 15 stores a relationship between the data of FIG. 5 or 10 and the original data of FIG. 4, and outputs address information S4 for deinterleaving. The address information S4 output from the second DMA device 15 is input to the main memory device 18, so that the interleaved output data DOUT of the descrambling device 20 is deinterleaved, and the original data as shown in FIG. 4 is stored into the main memory device 18.

The descrambling device 20 will be described in detail with reference to FIG. 2. Note that a process for descrambling is similar to the process for scrambling which has been described with reference to FIG. 3, and is performed by calculating a filter value and performing an EXOR operation of the obtained filter value and input data.

As shown in FIG. 2, the descrambling device 20 comprises a filter operation section 100 for obtaining a filter value which is updated by a shift operation for each byte, based on the data position information S2, and an EXOR operation section 110 for performing an EXOR operation of the input data DIN and a filter value FIV obtained by the filter operation section 100. The filter operation section 100 comprises an initial filter value holding section 101, a filter holding section 103, and operation sections 102, 104 and 105.

The initial filter value holding section 101 holds an initial filter value with respect to the descrambling unit. The initial value thus held corresponds to four bytes in the 0-th column. For the first descrambling unit, an initial filter value is obtained from the physical sector number S3. After one descrambling unit is processed, an initial value corresponding to the next four bytes in the 0-th column is required. Therefore, the operation section 102 performs an operation of shifting the initial filter value held in the initial filter value holding section 101 by four bytes so as to update the filter. The operation result is held as a new initial filter value in the initial filter value holding section 101. The initial filter value holding section 101 and the operation section 102 constitute an initial filter value setting section.

The operation section 104 as a first operation section has a function of advancing a filter value by 216 bytes, while the operation section 105 as a second operation section has a function of moving a filter value backward by 1836 (=2052−216) bytes. The filter holding section 103 holds the filter value FIV obtained by an operation of the operation section 104 or 105, and outputs the filter value FIV to the EXOR operation section 110.

As can be seen from FIG. 10, the input data DIN is 4-byte data wherein one input data DIN is spaced by 216 bytes from the next input data DIN. For example, when the ninth column is changed to the tenth column or the eighteenth column is changed to the nineteenth column, the sector is advanced by one, i.e., the sector number is incremented and the data number is reduced by 1836. Therefore, the filter value needs to be moved backward by 1836 bytes. Note that, in the second half of the interleave unit (i.e., the 108-th row and later), a point where the sector is advanced by one is a point where the eighth column is changed to the ninth column. Such a point where a sector is advanced can be obtained based on the data position information S2 which is output from the second DMA device 15.

The filter operation section 100 is operated as follows. Initially, for one descrambling unit, when the first four-byte data is input, an initial filter value held by the initial filter value holding section 101 is output, as it is, as the filter value FIV. When new four-byte data is input and the new four-byte data is of the same sector as that of the previous four-byte data, the operation section 104 performs an operation of advancing the filter value by 216 bytes, and outputs the resultant filter value FIV. On the other hand, when the sector is advanced by one from the previous four-byte data, the operation section 105 performs an operation of moving the filter value backward by 1836 bytes, and outputs the resultant filter value FIV.

For the next descrambling unit, the operation section 102 performs an operation for updating the filter, and sets an initial filter value into the initial filter value holding section 101. Thereafter, a process similar to that described above is performed.

By repeatedly executing such a process 54 times, the 216 rows of data of FIG. 10 are completely descrambled (one interleave unit). Note that the 217th row and some later rows constitute a parity region. The parity region does not need to be descrambled. Therefore, when the data position information S2 output from the second DMA device 15 indicates the parity region, an EXOR operation may be invalidated by setting the filter value FIV to be 0.

Specific methods for scrambling and descrambling operations will be now described.

In FIG. 3, if the current values of the seed 601 are assumed to be S0(N) to S15(N), values obtained by shifting these values once are as follows.

S0(N+1)=S3(N)+S12(N)+S14(N)+S15(N)

S1(N+1)=S0(N)

S2(N+1)=S1(N)

S3(N+1)=S2(N)

:

S13(N+1)=S12(N)

S14(N+1)=S13(N)

S15(N+1)=S14(N)

Values obtained by shifting twice are as follows.

S0(N+2)=S2(N)+S11(N)+S13(N)+S14(N)

S1(N+2)=S3(N)+S12(N)+S14(N)+S15(N)

S2(N+2)=S1(N)

S3(N+2)=S2(N)

:

S13(N+2)=S12(N)

S14(N+2)=S13(N)

S15(N+2)=S14(N)

Values obtained by shifting eight times (one byte) are as follows.

S0(N+8)=S0(N)+S5(N)+S7(N)+S8(N)+S9(N)+S11(N)+S12(N)

S1(N+8)=S1(N)+S6(N)+S8(N)+S9(N)+S10(N)+S12(N)+S13(N)

S2(N+8)=S2(N)+S7(N)+S9(N)+S10(N)+S11(N)+S13(N)+S14(N)

S3(N+8)=S3(N)+S8(N)+S10(N)+S11(N)+S12(N)+S14(N)+S15(N)

S4(N+8)=S0(N)+S9(N)+S11(N)+S12(N)

S5(N+8)=S1(N)+S10(N)+S12(N)+S13(N)

S6(N+8)=S2(N)+S11(N)+S13(N)+S14(N)

S7(N+8)=S3(N)+S12(N)+S14(N)+S15(N)

S8(N+8)=S0(N)

S9(N+8)=S1(N)

S10(N+8)=S2(N)

S11(N+8)=S3(N)

S12(N+8)=S4(N)

S13(N+8)=S5(N)

S14(N+8)=S6(N)

S15(N+8)=S7(N)

Thus, the scrambling filter can be advanced by a relative operation without depending on data on the disc.

The operation of advancing by 216 bytes which is used in this embodiment is as follows.

S0(N+1728)=S2(N)+S4(N)+S5(N)+S7(N)+S9(N)+S10(N)+S11(N)+S12(N)+S14(N)+S15(N)

S1(N+1728)=S0(N)+S3(N)+S4(N)+S5(N)+S6(N)+S8(N)+S10(N)+S11(N)+S12(N)

S2(N+1728)=S1(N)+S4(N)+S5(N)+S6(N)+S7(N)+S9(N)+S11(N)+S12(N)+S13(N)

S3(N+1728)=S2(N)+S5(N)+S6(N)+S7(N)+S8(N)+S10(N)+S12(N)+S13(N)+S14(N)

S4(N+1728)=S3(N)+S6(N)+S7(N)+S8(N)+S9(N)+S11(N)+S13(N)+S14(N)+S15(N)

S5(N+1728)=S0(N)+S7(N)+S8(N)+S9(N)+S10(N)+S12(N)+S13(N)+S14(N)

S6(N+1728)=S1(N)+S8(N)+S9(N)+S10(N)+S11(N)+S13(N)+S14(N)+S15(N)

S7(N+1728)=S0(N)+S2(N)+S4(N)+S9(N)+S10(N)+S11(N)+S12(N)+S13(N)+S14(N)

S8(N+1728)=S1(N)+S3(N)+S5(N)+S10(N)+S11(N)+S12(N)+S13(N)+S14(N)+S15(N)

S9(N+1728)=S0(N)+S2(N)+S6(N)+S11(N)+S12(N)+S14(N)

S10(N+1728)=S1(N)+S3(N)+S7(N)+S12(N)+S13(N)+S15(N)

S11(N+1728)=S0(N)+S2(N)+S8(N)+S14(N)+S15(N)

S12(N+1728)=S0(N)+S1(N)+S3(N)+S4(N)+S9(N)+S13(N)

S13(N+1728)=S1(N)+S2(N)+S4(N)+S5(N)+S10(N)+S14(N)

S14(N+1728)=S2(N)+S3(N)+S5(N)+S6(N)+S11(N)+S15(N)

S15(N+1728)=S0(N)+S3(N)+S6(N)+S7(N)+S12(N)+S13(N)+S15(N)

An expression for the operation of moving the scramble filter backward can be obtained by performing an inverse operation to the above-described operation of shifting once. Specifically, the operation of shifting backward once is as follows.

S0(N)=S1(N+1)

S1(N)=S2(N+1)

S2(N)=S3(N+1)

S3(N)=S4(N+1)

:

S13(N)=S14(N+1)

S14(N)=S15(N+1)

S15(N)=S0(N+1)+S4(N+1)+S13(N+1)+S15(N+1)

By utilizing the above-described expression, an expression for the operation of moving backward can be created as is similar to the operation of advancing. An operation of moving backward by 1836 bytes as used in this embodiment is as follows.

S0(N−14688)=S1(N)+S3(N)+S4(N)+S5(N)+S6(N)+S8(N)+S10(N)

S1(N−14688)=S2(N)+S4(N)+S5(N)+S6(N)+S7(N)+S9(N)+S11(N)

S2(N−14688)=S3(N)+S5(N)+S6(N)+S7(N)+S8(N)+S10(N)+S12(N)

S3(N−14688)=S4(N)+S6(N)+S7(N)+S8(N)+S9(N)+S11(N)+S13(N)

S4(N−14688)=S5(N)+S7(N)+S8(N)+S9(N)+S10(N)+S12(N)+S14(N)

S5(N−14688)=S6(N)+S8(N)+S9(N)+S10(N)+S11(N)+S13(N)+S15(N)

S6(N−14688)=S0(N)+S4(N)+S7(N)+S9(N)+S10(N)+S11(N)+S12(N)+S13(N)+S14(N)+S15(N)

S7(N−14688)=S0(N)+S1(N)+S4(N)+S5(N)+S8(N)+S10(N)+S11(N)+S12(N)+S14(N)

S8(N−14688)=S1(N)+S2(N)+S5(N)+S6(N)+S9(N)+S11(N)+S12(N)+S13(N)+S15(N)

S9(N−14688)=S0(N)+S2(N)+S3(N)+S4(N)+S6(N)+S7(N)+S10(N)+S12(N)+S14(N)+S15(N)

S10(N−14688)=S0(N)+S1(N)+S3(N)+S5(N)+S7(N)+S8(N)+S11(N)

S11(N−14688)=S1(N)+S2(N)+S4(N)+S6(N)+S8(N)+S9(N)+S12(N)

S12(N−14688)=S2(N)+S3(N)+S5(N)+S7(N)+S9(N)+S10(N)+S13(N)

S13(N−14688)=S3(N)+S4(N)+S6(N)+S8(N)+S10(N)+S11(N)+S14(N)

S14(N−14688)=S4(N)+S5(N)+S7(N)+S9(N)+S11(N)+S12(N)+S15(N)

S15(N−14688)=S0(N)+S4(N)+S5(N)+S6(N)+S8(N)+S10(N)+S12(N)+S15(N)

Thus, according to this embodiment, an input data stream is halfway deinterleaved, and the resultant scrambled interleaved data can be deinterleaved while being descrambled.

Although it has been assumed in this embodiment that the descrambling device 20 receives and descrambles interleaved data in units of four bytes, the unit (the number of bytes) of input data in which the descrambling device 20 may receive the input data is not limited to this and may be any n bytes (n is a positive integer).

Although it has also been assumed in this embodiment that the interleave memory 13 stores data in descrambling units of four rows, the descrambling unit (the number of rows) is not limited to this. Although it has also been assumed in this embodiment that the number of rows of data in the descrambling unit stored in the interleave memory 13 is the same as the number of bytes of input data to the descrambling device 20, these do not necessarily need to be the same. The number of rows of data stored in the interleave memory 13 may be larger than the number of bytes of input data to the descrambling device 20. For example, eight rows of data may be stored in the interleave memory 13, and input data to the descrambling device 20 may be of four bytes, so that descrambling may be performed two times.

### Second Embodiment

The configuration and operation of a data transfer device according to a second embodiment of the present invention are similar to those of the first embodiment of FIG. 1, except for the internal configuration and operation of the descrambling device.

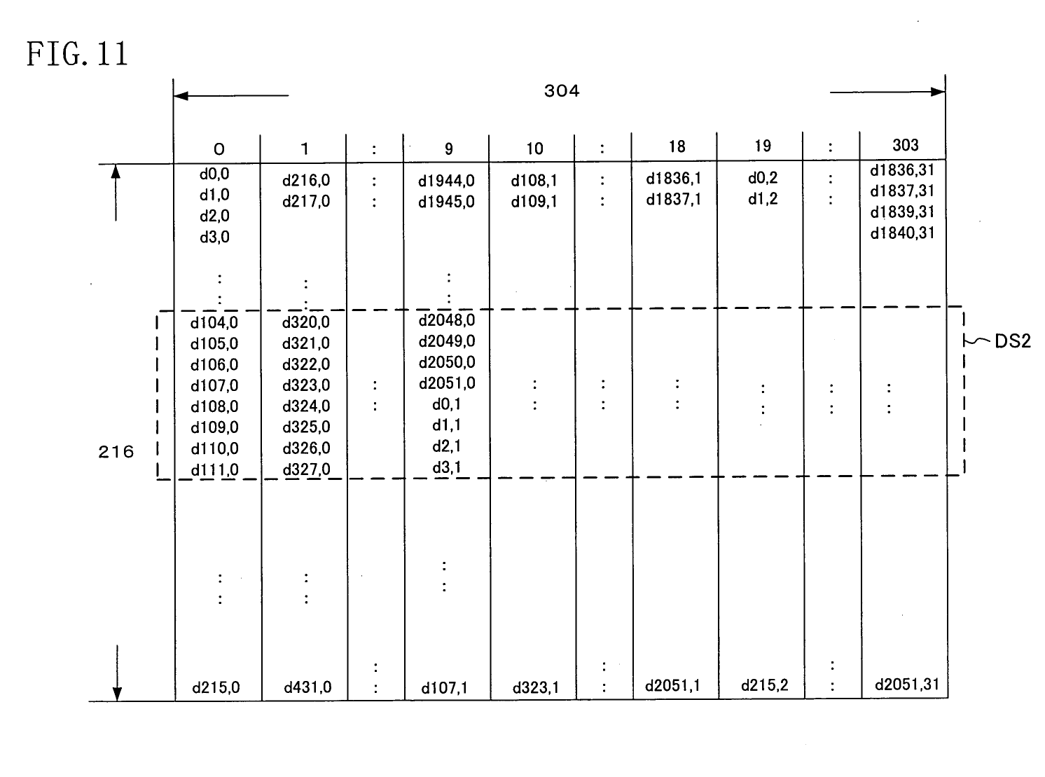

In this embodiment, the data stream of FIG. 9 is assumed to be deinterleaved in units of 16 rows. Thereby, eight rows of data (data DS2 shown in FIG. 11) is stored in the interleave memory 13. In other words, in this embodiment, the descrambling unit is eight rows of data.

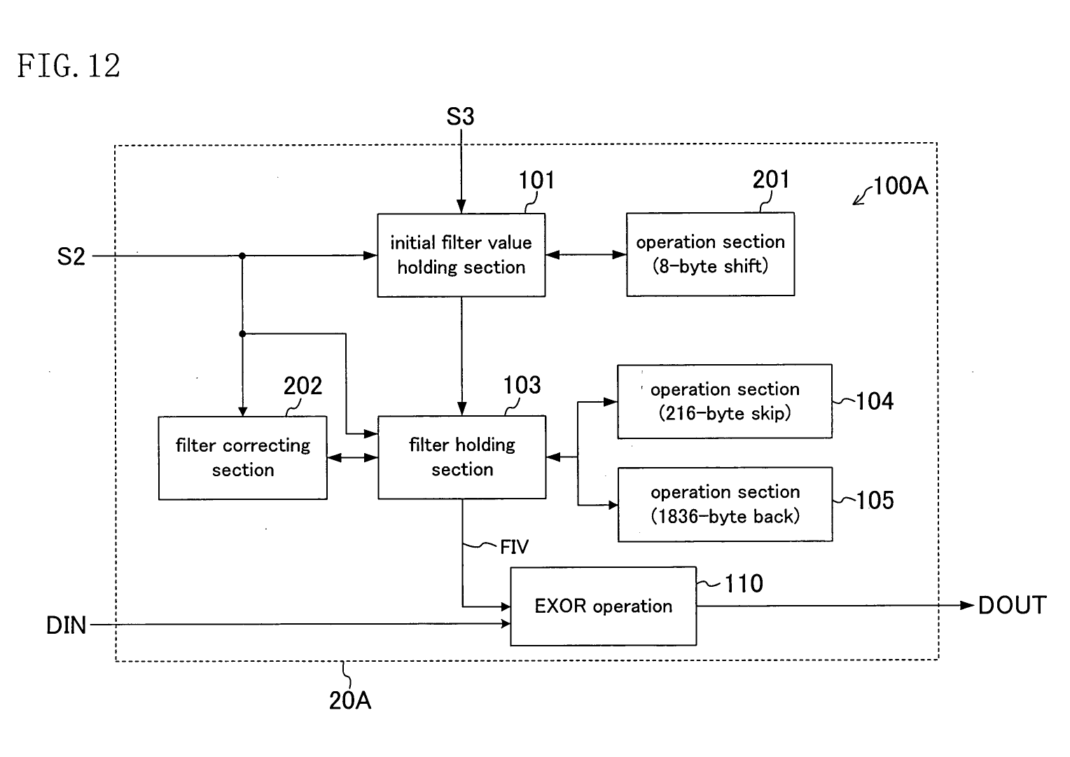

FIG. 12 is a block diagram showing an internal configuration of a descrambling device 20A according to this embodiment. Comparing with the first embodiment of FIG. 2, the filter operation section 100A comprises an operation section 201 instead of the operation section 102, and additionally, a filter correcting section 202.

In this embodiment, after one descrambling unit is processed, an initial filter value for the next eight bytes in the 0th column is required. Therefore, the operation section 201 performs an operation of shifting the initial filter value held in the initial filter value holding section 101, by eight bytes, so as to update the filter. The operation result is held as a new initial filter value in the initial filter value holding section 101.

Also, in this embodiment, the following new problem arises. Specifically, new 8-byte data input to the descrambling device 20A may include a portion which is of the same sector to which the previous 8-byte data belongs and a portion which is of a sector which advances by one. For example, as shown in FIG. 11, the boundary between sector 0 and sector 1 is located between the 108th row and the 109th row in the ninth column. When the descrambling unit is assumed to be eight rows of data as in this embodiment, 108 is not divisible by 8, so that the 8-byte data in the ninth column of the data DS2 includes four bytes in the same sector as that of 8-byte data in the previous column (the eighth column) and four bytes in a sector which advances by one. Note that such coexistence of sectors occurs in 8-byte data in a (19m+9)th column (m=0 to 15) in the descrambling unit of the 103rd to 110th rows (data DS2).

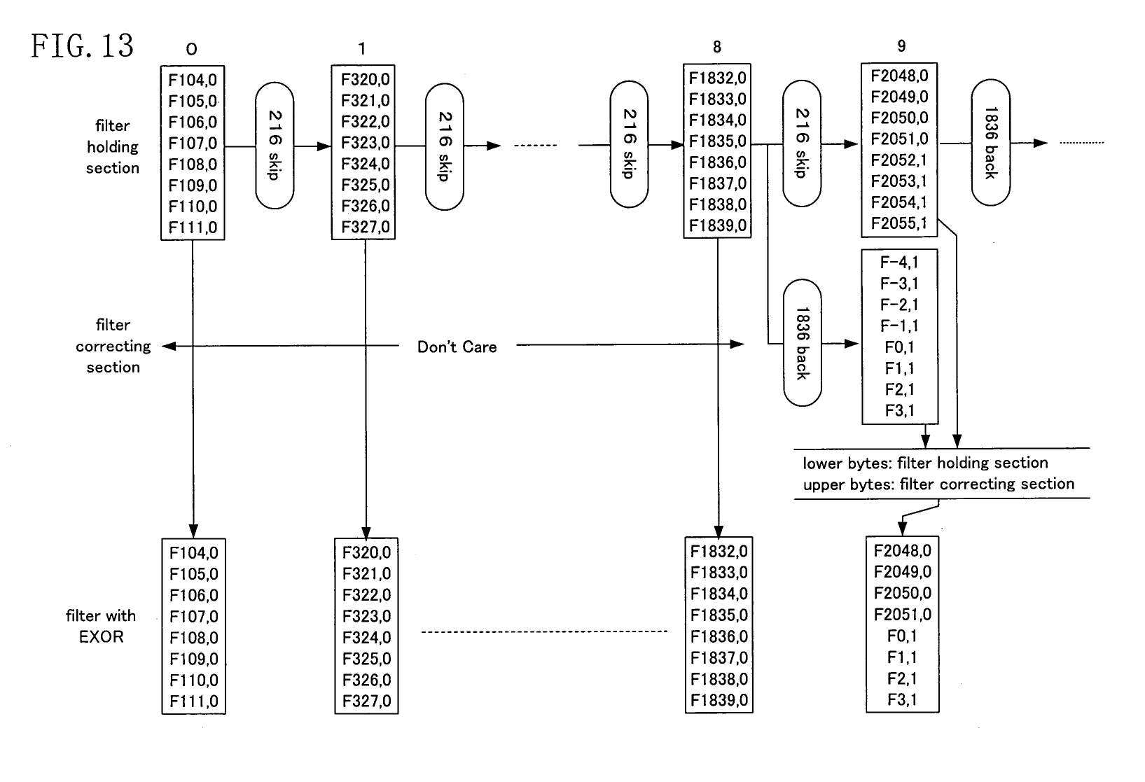

Therefore, in this embodiment, in order to address this problem, the filter correcting section 202 is additionally provided. FIG. 13 is a diagram schematically showing a filter updating process when the coexistence of sectors occurs in input 8-byte data. As shown in FIG. 13, when newly input 8-byte data is of the same sector as that of the previous 8-byte data, the operation section 104 performs an operation of advancing the filter value by 216 bytes. The resultant filter value is stored into the filter holding section 103 and is output to the EXOR operation section 110. In this case, the filter correcting section 202 is not particularly operated.

On the other hand, when newly input 8-byte data includes a first portion which is of the same sector as that of the previous 8-byte data and a second portion which is of a sector which advances by one, the operation sections 104 and 105 perform the respective operations. A filter value obtained by the operation by the operation section 104 (advanced by 216 bytes) is output with respect to the first portion, while a filter value obtained by the operation by the operation section 105 (moved backward by 1836 bytes) is output with respect to the second portion. Specifically, for example, the operation result of the operation section 104 is stored into the filter holding section 103, while the operation result of the operation section 105 is stored into the filter correcting section 202. The lower four bytes of data held in the filter holding section 103 and the upper four bytes of data held in the filter correcting section 202 are combined and output as a filter value to the EXOR operation section 110.

For the next 8-byte data, the operation section 105 can perform an operation (moving backward by 1836 bytes) with respect to the data held in the filter holding section 103 to generate a filter value. Note that, in this case, the operation section 104 can also perform an operation (advancing by 216 bytes) with respect to the data held in the filter correcting section 202 to generate a filter value.

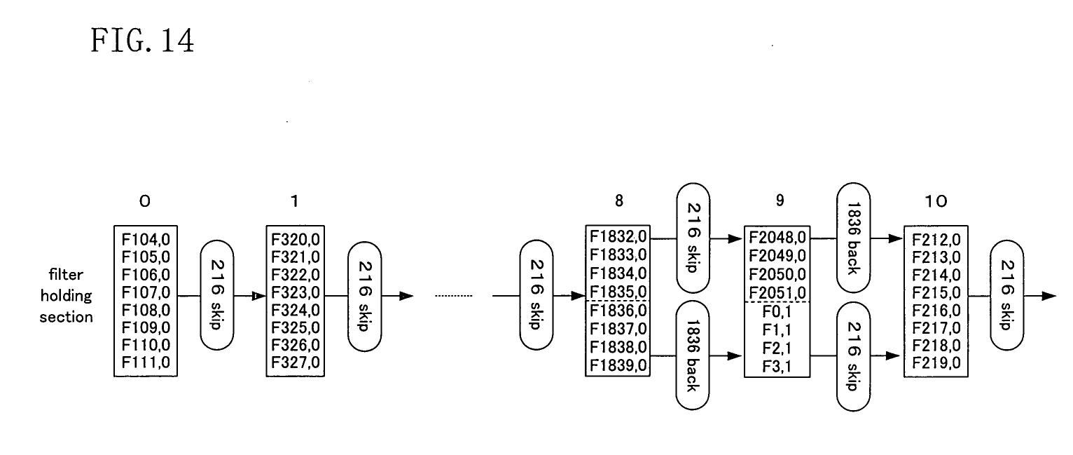

Note that the filter updating process when the coexistence of sectors occurs in input 8-byte data is not limited to that shown in FIG. 13, and may be contemplated to be achieved in some other manners. FIG. 14 is a diagram schematically showing another filter updating process. Specifically, the operation section 104 performs an operation (advancing by 216 bytes) with respect to the lower four bytes of a filter value, while the operation section 105 performs an operation (moving backward by 1836 bytes) with respect to the upper bytes of a filter value. The operation results are combined and output as a filter value to the EXOR operation section 110. For the next 8-byte data, the operation section 105 executes an operation (moving backward by 1836 bytes) with respect to the lower four bytes of a filter value, while the operation section 104 executes an operation (advancing by 216 bytes) with respect to the upper four bytes of a filter value, thereby making it possible to generate a filter value. The process of FIG. 14 does not require the filter correcting section 202.

### Third Embodiment

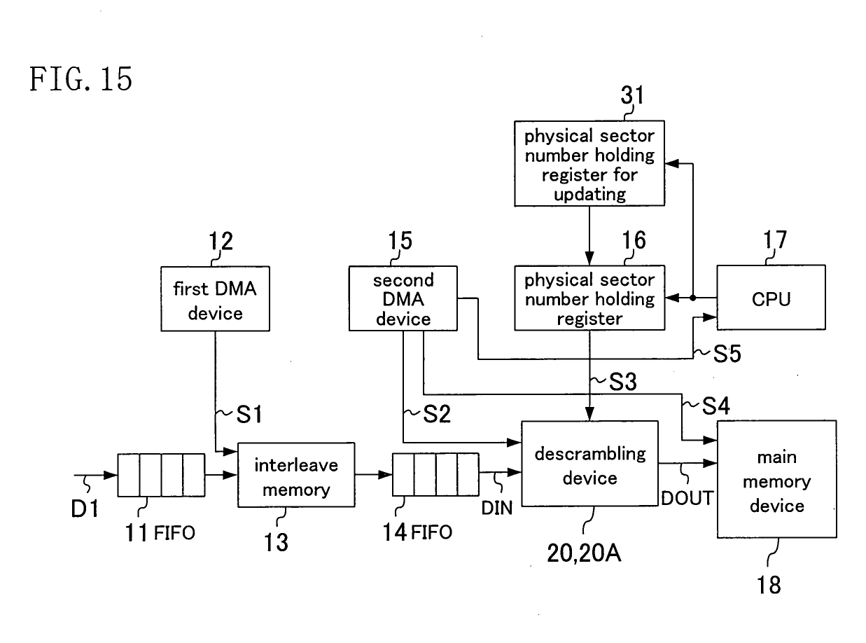

FIG. 15 is a block diagram showing a configuration of a data transfer device according to a third embodiment of the present invention. The configuration of the third embodiment is different from that of the first embodiment of FIG. 1 in that a physical sector number holding register 31 for updating is additionally provided.

In the first embodiment, the CPU 17 sets a physical sector number into the physical sector number holding register 16 for each interleave unit. In this case, for example, when data is smoothly transferred from an optical disc, a higher speed with which a physical sector number is updated by the CPU 17 is required as the transfer speed is increased by double-speed reading or the like. Therefore, if the transfer speed is excessively high, the process of updating a physical sector number is likely to fail.

Therefore, in this embodiment, the physical sector number holding register 31 for updating is additionally provided. The CPU 17 sets a physical sector number for the next interleave unit into the physical sector number holding register 31 for updating during transfer of one interleave unit. When the transfer of the one interleave unit is completed, the physical sector number held in the physical sector number holding register 31 for updating is set into the physical sector number holding register 16. The CPU 17 is notified of the end of the transfer using an end signal S5 from the second DMA device 15.

Thereby, initial values can be seamlessly updated between interleave units without requiring the CPU 17 for an excessive processing speed.

### Fourth Embodiment

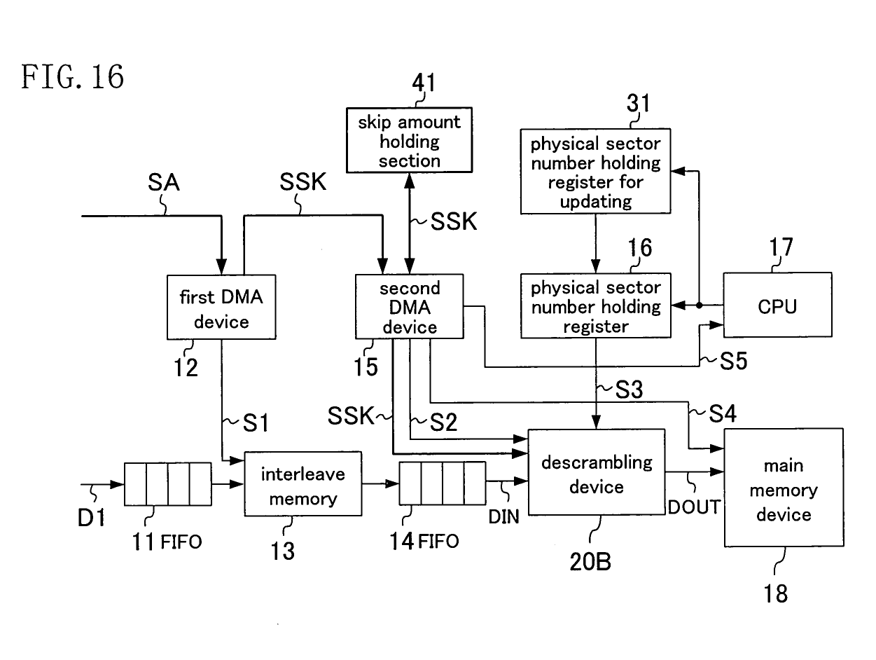

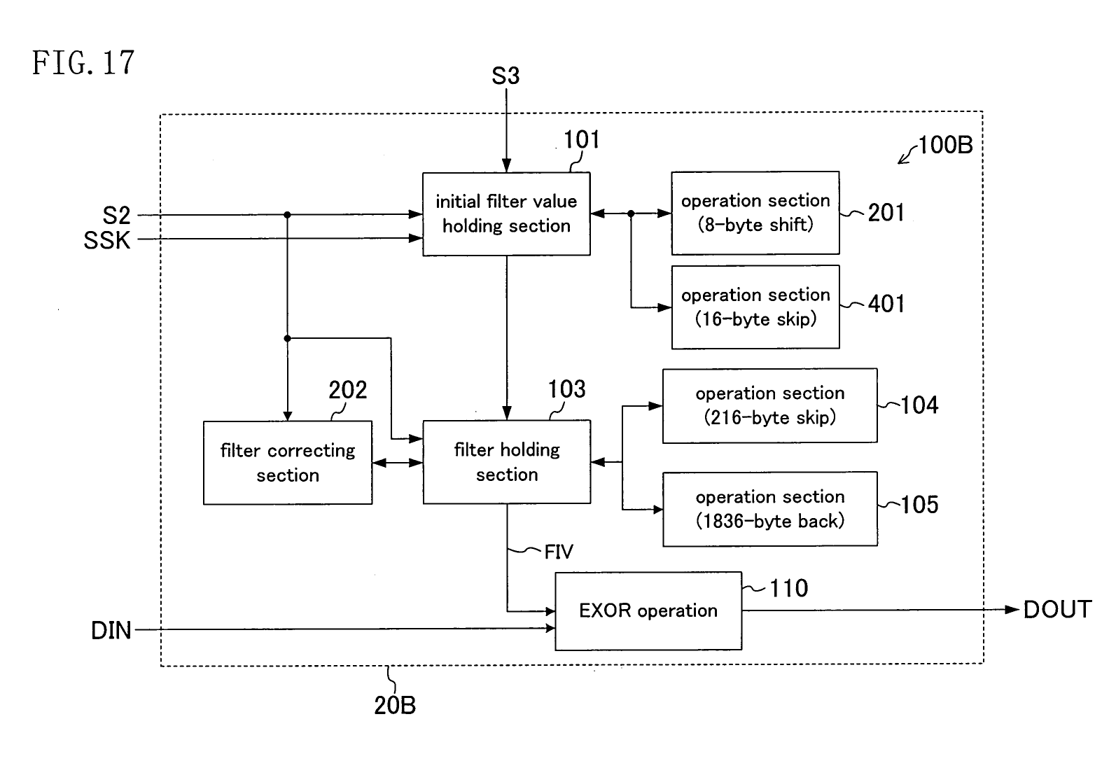

FIG. 16 is a block diagram showing a configuration of a data transfer device according to a fourth embodiment of the present invention. FIG. 17 is a block diagram showing an internal configuration of a descrambling device 20B of FIG. 16.

In this embodiment, as in the second embodiment, it is assumed that the data stream of FIG. 9 is deinterleaved in units of 16 rows. Thereby, eight rows of data (data DS2 of FIG. 11) is stored in the interleave memory 13. In other words, in this embodiment, the descrambling unit is data of eight rows.

It is also assumed in this embodiment that a synchronization detecting section (not shown) for performing synchronization detection so as to reproduce the data stream D1 is provided before the data transfer device. When synchronization abnormality (data deviation) occurs in the data stream D1, the synchronization detecting section outputs a signal SA which notifies data jump for correcting data synchronization. The first DMA device 12, when receiving the signal SA, calculates a skip amount (in the descrambling units), and outputs a signal SSK indicating the skip amount. The descrambling device 20B receives the signal SSK via the second DMA device 15, and updates an initial filter value, depending on the skip amount indicated by the signal SSK. In order to achieve the updating, a filter operation section 100B comprises an operation section 401 for performing an operation of shifting an initial filter value held in the initial filter value holding section 101 by 16 bytes.

The synchronization detection is generally performed based on a synchronization detection signal called SYNC. In the data stream of FIG. 9, the leftmost one byte corresponds to SYNC. According to the Blu-ray standards, SYNC has a periodicity of 31 rows (this is called an address unit).

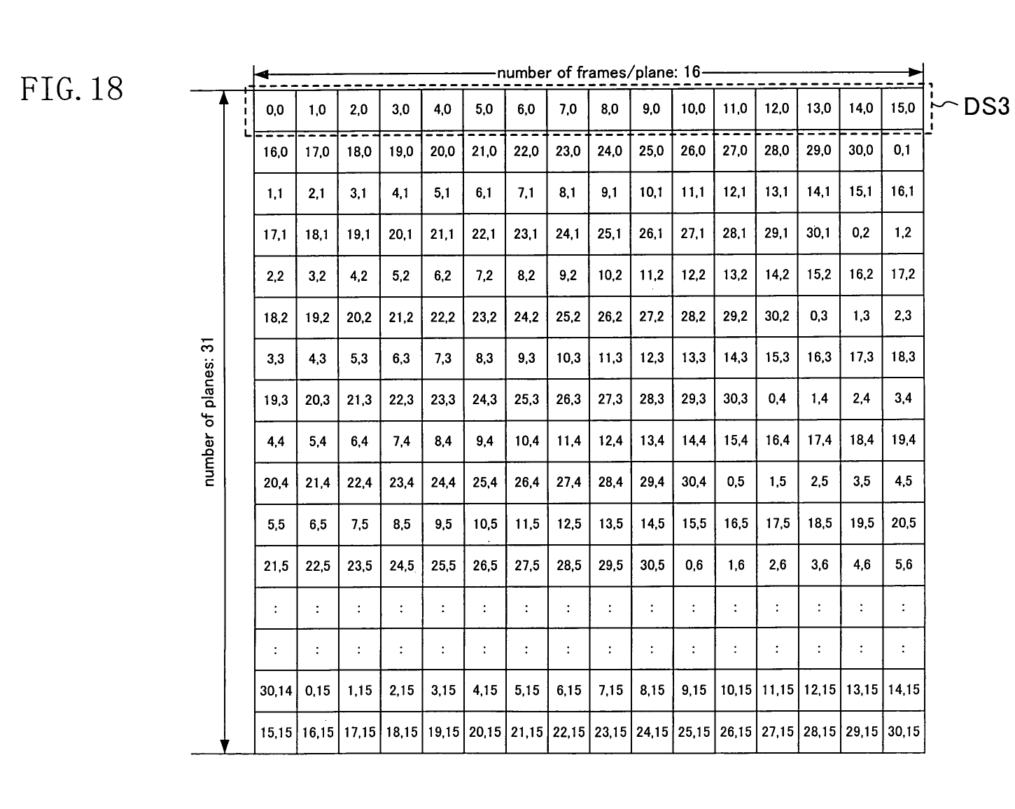

FIG. 18 is a diagram showing data of one interleave unit for describing an operation in this embodiment. In FIG. 18, each square represents a frame, and one frame corresponds to one row of data in the data stream of FIG. 9. Numerical figures in each square represent (a frame number, an address unit number). Interleaving units, address units, and frames have the following relationship.
1 address unit=31 frames
1 interleave unit=16 address units

In this embodiment, since the data stream of FIG. 9 is deinterleaved in units of 16 rows, frames are arranged in rows each of which includes 16 frames in FIG. 18. Each row of FIG. 18 is here referred to as a plane. For example, data DS3 of 16 frames corresponding to one plane is the descrambling unit.

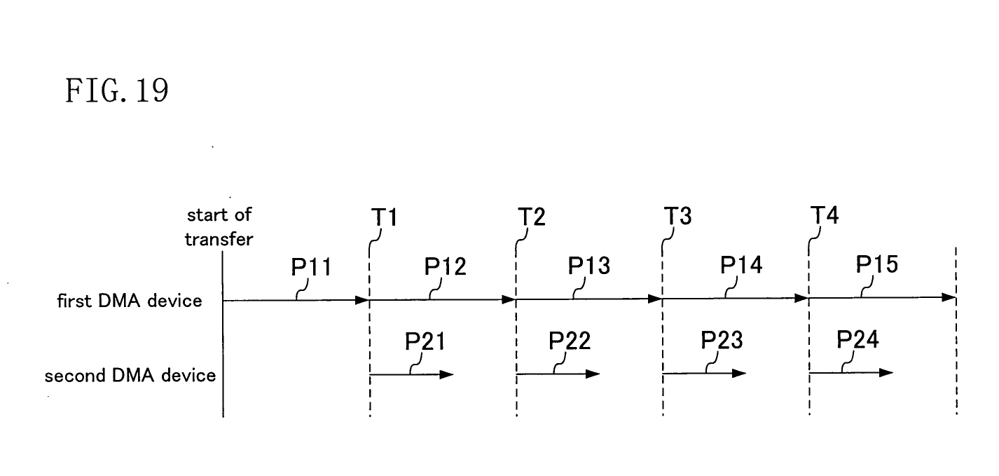

FIG. 19 is a diagram showing timing of a normal interleaving operation. As shown in FIG. 19, the first DMA device 12 initially deinterleaves data of the first plane (the data DS3 of FIG. 18) in a time zone P11 ranging from the start of transfer until timing Ti. Next, the second DMA device 15 further deinterleaves the first plane data which has been halfway deinterleaved, during a time zone P21 ranging from the timing T1. At the same time, the first DMA device 12 deinterleaves data of the second plane during a time zone P12 ranging until timing T2. Next, the second DMA device 15 further deinterleaves the second plane data which has been halfway deinterleaved, during a time zone P22 ranging from the timing T2. In this manner, deinterleaving is successively performed.

In this embodiment, the first DMA device 12, when receiving a notification of data jump from the synchronization detecting section using the signal SA, discards data of an address unit which is being transferred, and immediately starts transferring data of a plane including the next address unit.

In this case, the movement amount of the plane (i.e., the skip amount of the descrambling unit) varies, depending on which frame is being transferred. For example, in FIG. 18, when data jump is notified of during transfer of frames (0, 0) to (15, 0) of the first plane, the first frame (0, 1) of the next address unit exists in the second plane. Therefore, the plane needs to be advanced by one. Also, when data jump is notified of during transfer of frames (16, 0) to (0, 1) of the second plane, the movement amount of the plane varies, depending on the frame. Specifically, for frames (16, 0) to (30, 0), since the first frame (0, 1) of the next address unit exists in the same second plane, the plane does not need to be changed. On the other hand, for the frame (0, 1), since the first frame (0, 2) of the next address unit exists in the second next plane (fourth plane), the plane needs to be advanced by two. Further, when data jump is notified of during transfer frames (1, 1) to (16, 1) of the third plane, the first frame (0, 2) of the next address unit exists in the next plane (fourth plane). Therefore, the plane needs to be advanced by one.

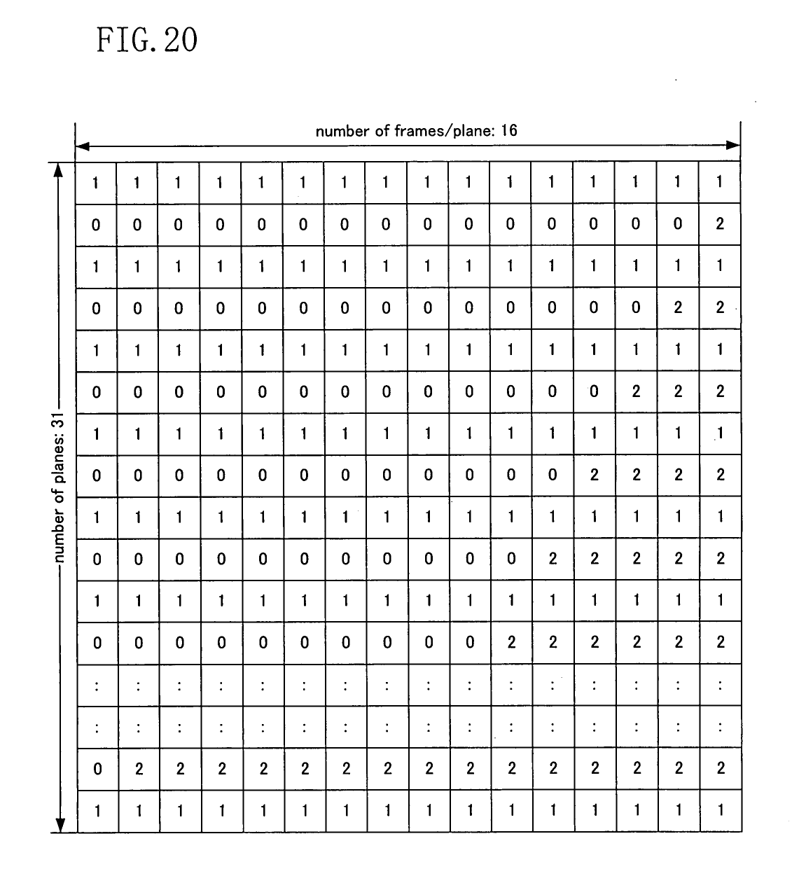

Similarly, a relationship between frames and the movement amounts of planes is as shown in FIG. 20. This is represented by the following expression using the current address unit number and frame number.

The movement amount of a plane=
2 when the address unit number>the frame number
1 when the address unit number+16>the frame number
0 when otherwise

The first DMA device 12, when is notified of data jump using the signal SA, calculates the movement amount of a plane (i.e., the skip amount of the descrambling unit), depending on the address unit number and frame number of a frame which is being currently transferred in accordance with the expression above. The second DMA device 15 is notified of the calculated skip amount using the signal SSK.

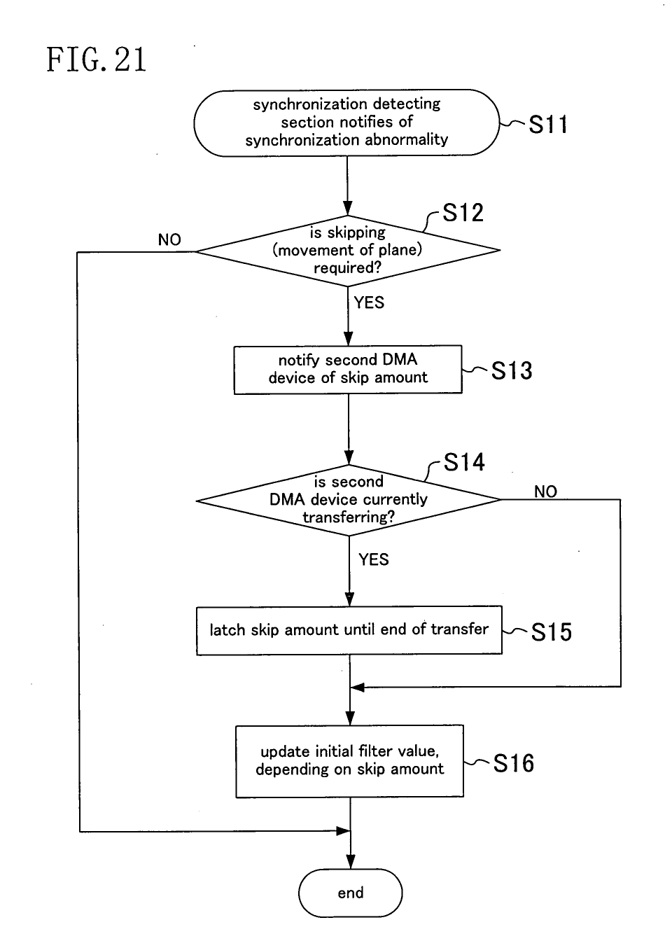

FIG. 21 is a flowchart showing an operation when synchronization abnormality occurs.

Initially, when the synchronization detecting section notifies of synchronization abnormality (data jump) (S11), the first DMA device 12 determines whether or not the movement of a plane (i.e., skipping of the descrambling unit) is required (S12). Here, when data jump occurs, but skip is not required, the operations of the second DMA device 15 and the descrambling device 20B are not affected. Therefore, an operation is not particularly performed.

On the other hand, when skip is required, the second DMA device 15 is notified of a skip amount using the signal SSK (S13). In this case, the subsequent operation varies, depending on whether or not the second DMA device 15 is transferring data.

Initially, when the second DMA device 15 is not transferring data, the second DMA device 15 notifies the descrambling device 20B of a skip amount using the signal SSK. In the descrambling device 20B, when the skip amount is 1, the operation section 201 executes an operation of shifting by 8 bytes to update the initial filter value, and when the skip amount is 2, the operation section 401 executes an operation of shifting 16 bytes to update the initial filter value (S16).

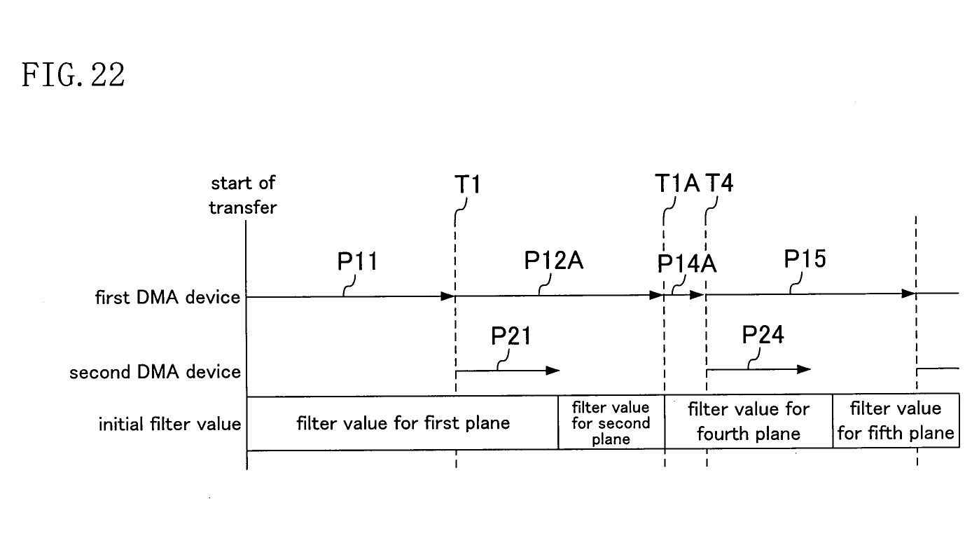

FIG. 22 is a diagram showing exemplary operation timing in this case. It is here assumed that the first DMA device 12 is notified of data jump at timing T1A during transfer of frame (0, 1), during transfer of the second plane data (period P12A). According to the specifications of this embodiment, a portion (frames (16, 0) to (0, 1)) of the second plane data is discarded. The data stream D1 to be next transmitted is data ranging from the first frame (0, 2) of the next address unit. The first DMA device 12 transfers frames (0, 2) to (1, 2) as fourth plane data (period P14A). In this case, frames (17, 1) to (30, 1) have inconstant values.

In this case, the first DMA device 12 notifies the second DMA device 15 of 2 as a skip amount. Since the second DMA device 15 is not currently performing transfer, the second DMA device 15 notifies the descrambling device 20B of 2 as a skip amount. The descrambling device 20B updates the initial filter value in an amount corresponding to two scrambling units. Specifically, the operation section 401 performs an operation of shifting by 16 bytes to update the initial filter value. As a result, the initial filter value for the scrambling unit corresponding to the fourth plane data is held in the initial filter value holding section 101. At timing T4, when the first DMA device 12 ends transferring the fourth plane data, the second DMA device 15 starts transfer and the descrambling device 20B executes descrambling.

Referring back to FIG. 21, when the second DMA device 15 is notified of the skip amount (S13) and the second DMA device 15 is transferring data (YES in S14), the second DMA device 15 causes the skip amount holding section 41 to temporarily hold the notified skip amount. Thereafter, when data transfer is ended, the second DMA device 15 notifies the descrambling device 20B of the skip amount held by the skip amount holding section 41 using the signal SSK. The descrambling device 20B updates the initial filter value, depending on the notified skip amount.

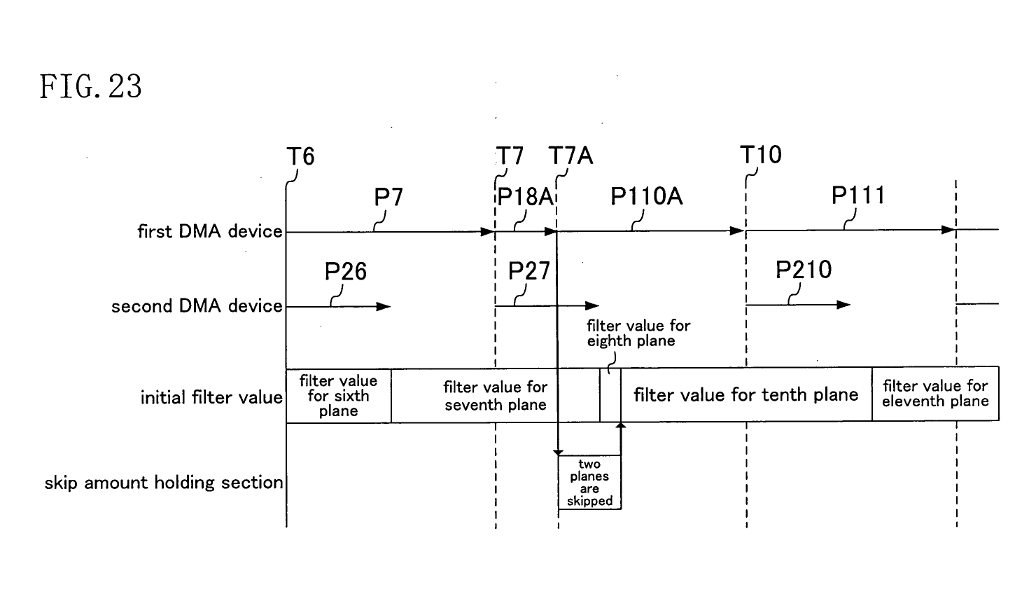

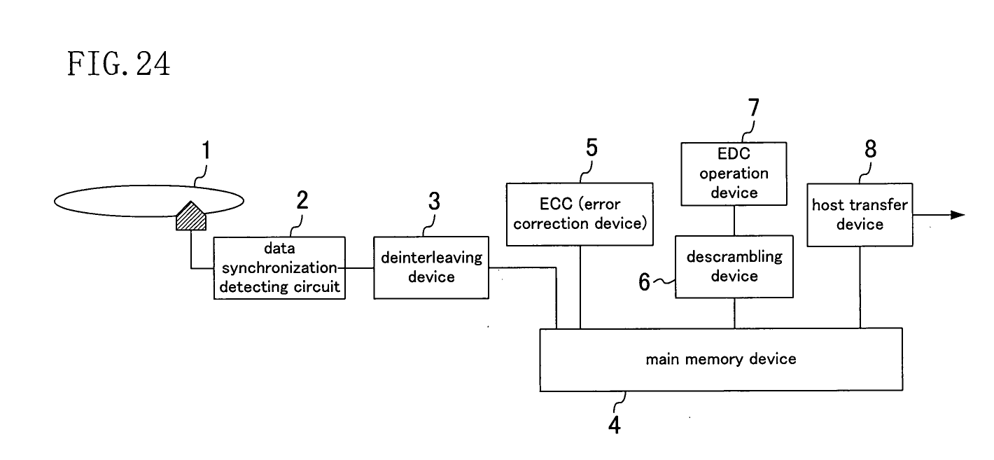

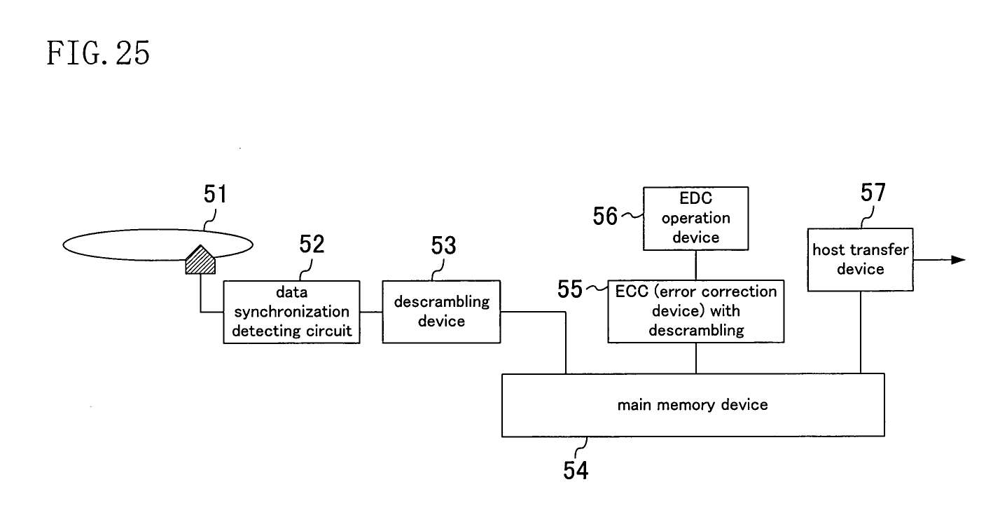

FIG. 23 is a diagram showing exemplary operation timing in this case. It is here assumed that, when the first DMA device 12 is transferring eighth plane data (period P18A) and the second DMA device 15 is transferring seventh plane data (period P27), data jump is notified of at timing T7A when the first DMA device 12 is transferring frame (1, 4). According to the specifications of this embodiment, a portion (frames (19, 3) to (1, 4)) of the eighth plane data is discarded. A data stream D1 to be next transmitted is data ranging from the first frame (0, 5) of the next address unit. The first DMA device 12 transfers frames (0, 5) to (4, 5) as tenth plane data (period P110A). In this case, frames (20, 4) to (30, 4) have inconstant values.

In this case, the first DMA device 12 notifies the second DMA device 15 of 2 as a skip amount. Since the second DMA device 15 is currently performing transfer, the second DMA device 15 does not notify the descrambling device 20B of the skip amount, and causes the skip amount holding section 41 to hold the skip amount. Thereafter, the second DMA device 15 ends transfer of the seventh plane data. When the transfer is ended, the initial filter value is updated in the descrambling device 20B.

Thereafter, the second DMA device 15 notifies the descrambling device 20B of the skip amount held in the skip amount holding section 41. When receiving 2 as a skip amount, the descrambling device 20B updates the initial filter value in an amount corresponding two scrambling units. Specifically, the operation section 401 executes an operation of shifting by 16 bytes to update the initial filter value. As a result, in the initial filter value holding section 101, an initial filter value for a scrambling unit corresponding to the tenth plane data is held. When the first DMA device 12 ends transfer of the tenth plane data at timing T10, the second DMA device 15 starts transfer and the descrambling device 20B executes descrambling.

According to this embodiment, it is possible to execute descrambling in an interleave, following synchronization abnormality which may occur in an optical disc or the like. Thereby, data after synchronization abnormality is normally transferred, and therefore, the data may be corrected by error correction on the subsequent stage, resulting in an increase in data readability. Also, in the case of synchronization abnormality in a small unit (frame unit), all the synchronization abnormality is contained in an interleave before descrambling and is therefore negligible, so that it is not necessary to add a circuit.

Although it has been assumed in this embodiment that, when synchronization abnormality occurs, data jump is performed, a similar technique can be applied to a case where data back is performed.

Although it has also been assumed in this embodiment that, when data jump is performed, the first DMA device discards data, data may not be discarded. In this case, in the flow of FIG. 21, the NO branch of step S14 can be removed. Specifically, when data jump occurs, the first DMA device 12 ends data transfer of a plane in which data jump occurs, and the second DMA device 15 starts data transfer of the plane. The notified skip amount is held in the skip amount holding section 41 until the end of transfer of the second DMA device 15. Meanwhile, the first DMA device 12 transfers data of the next plane to another space of the interleave memory 13. When the transfer of the second DMA device 15 is ended, the initial filter value is updated, depending on the skip amount.

Note that, in each embodiment above, according to the Blu-ray standards, 32 sectors of scrambled original data (2052 bytes/sector) are arranged into 216 rows×304 columns, which is defined as an interleave unit, the present invention is not limited to this. In general, the present invention can also be achieved when B sectors of original data (A bytes/sector) are arranged into C rows×D columns (A, B, C, and D are positive integers, and A×B=C×D), which is defined as an interleave unit.

The present invention is widely applicable in a communications field in which interleaved and scrambled data is transferred with high speed, particularly in an optical disc field.

What is claimed is:

1. A data transfer device for descrambling and deinterleaving scrambled interleaved data and transferring the resultant data to a main memory device, wherein the interleaved data has an interleave unit including B sectors of scrambled original data (A bytes/sector) arranged in C rows×D columns (A, B, C, and D are positive integers, A×B=C×D), the device comprising:
an interleave memory for storing the interleaved data in descrambling units, the describing unit being a group of data to be descrambled;
a DMA device for outputting data position information indicating a storage position of each byte of the interleaved data stored in the interleave memory, and address information for deinterleaving; and
a descrambling device for receiving data read out from each column of the interleave memory in units of n bytes (n is a positive integer), and descrambling the data based on the data position information output from the DMA device,
wherein the address information output from the DMA device is supplied to the main memory device while the output data of the descrambling device is transferred to the main memory device,
the descrambling device comprises:
a filter operation section for obtaining a filter value to be updated by a shift operation on a byte-by-byte basis based on the data position information; and
an EXOR operation section for performing an EXOR operation of input data and the filter value obtained by the filter operation section.

2. The data transfer device of claim 1, wherein the interleave memory stores n rows of the interleaved data as the descrambling unit.

3. The data transfer device of claim 1, wherein A is 2052, B is 32, C is 216, and D is 304.

4. The data transfer device of claim 1, wherein
the filter operation section comprises:
an initial filter value setting section for setting an initial filter value with respect to the descrambling unit;
a first operation section for advancing a filter value by C bytes; and
a second operation section for moving a filter value backward by (A−C) bytes, and
when first n-byte data is input, the filter operation section outputs the initial value set by the initial filter value setting section, and
when new n-byte data is input, then if the new n-byte data is of the same sector as that of the previous n-byte data, the first operation section executes an operation and outputs the resultant filter value, or if the new n-byte data is of a sector advancing by 1 from the previous n-byte data, the second operation section executes an operation and outputs the resultant filter value.

5. The data transfer device of claim 4, wherein, in the filter operation section, when new n-byte data is input, then if the new n-byte data has a first portion which is of the same sector as that of the previous n-byte data and a second portion which is of a sector advancing by 1 from the previous n-byte data, the first and second operation sections execute respective operations, and a filter value obtained by the operation by the first operation section is output to the first portion, while a filter value obtained by the operation by the second operation section is output to the second portion.

6. The data transfer device of claim 1, further comprising:
a physical sector number holding register; and
a CPU for setting a physical sector number into the physical sector number holding register for each interleave unit,
wherein the filter operation section sets an initial filter value based on the physical sector number held in the physical sector number holding register.

7. The data transfer device of claim 6, further comprising:
a physical sector number holding register for updating,
wherein, when one interleave unit is being transferred, the CPU sets a physical sector number for the next interleave unit into the physical sector number holding register for updating, and when the transfer of the one interleave unit is ended, the physical sector number held in the physical sector number holding register for updating is set into the physical sector number holding register.

8. The data transfer device of claim 1, wherein an input data stream is halfway deinterleaved, and the input data stream is stored as the interleaved data into the interleave memory.

9. The data transfer device of claim 8, wherein, when synchronization abnormality occurs in the data stream, the descrambling device receives a skip amount of a descrambling unit, and updates an initial filter value, depending on the skip amount.

10. The data transfer device of claim 8, wherein the data stream is reproduced from an optical disc.
